(19) United States
(12) Patent Application Publication
(10) Pub. No.: US 2010/0127129 A1
(43) Pub. Date: May 27, 2010

(54) High performance airfoil with co-flow jet flow control

(75) Inventors: GeChen Zha, Village of Palmetto Bay, FL (US); Craig Paxton, Pompano Beach, FL (US)

Correspondence Address: NIXON & VANDERHYE, PC, 901 NORTH GLEBE ROAD, 11TH FLOOR, ARLINGTON, VA, 22203, US

(73) Assignee: University of Miami, Miami, FL (US)

(21) Appl. No.: 12/461,167

(22) Filed: Aug. 3, 2009

Related U.S. Application Data
(63) Continuation of application No. 11/064,053, filed on Feb. 23, 2005, now abandoned.
(60) Provisional application No. 60/603,212, filed on Aug. 20, 2004.

(51) Int. Cl. B64C 21/04; B64C 21/06

(52) U.S. Cl. 244/208

(57) ABSTRACT

An aerodynamic system providing an airfoil having a chord length, a leading edge, and a trailing edge. The airfoil further includes a first airfoil surface extending from the leading edge to the trailing edge, a second airfoil surface opposite the first airfoil surface, extending from the leading edge to the trailing edge, an injection opening in the first airfoil surface, and a recovery opening in the first airfoil surface located between the injection opening and the trailing edge. A pressurized fluid source is in fluid communication with the injection opening and a vacuum source is in fluid communication with the recovery opening. An exemplary use of the aerodynamic system of the present invention provides the ejection of a mass of fluid out of the injection opening along a surface of the airfoil and drawing a mass of fluid into the recovery opening.

### CROSS-REFERENCE TO RELATED APPLICATION

This application is related to and claims priority to U.S. Provisional Patent Application Ser. No. 60/603,212, filed Aug. 20, 2004, entitled HIGH PERFORMANCE AIRFOIL WITH CO-FLOW JET FLOW CONTROL, the entirety of which is incorporated herein by reference.

### STATEMENT REGARDING FEDERALLY SPONSORED RESEARCH OR DEVELOPMENT

This invention was made by an agency of the United States government or under a contract with an agency of the United States Government. The name of the U.S. Government agency and the Government contract number are NASA-Contract No. NNL04AA39C.

### FIELD OF THE INVENTION

The present invention relates to airfoils and flow control.

### BACKGROUND OF THE INVENTION

Selected airframe, wing and control surface configurations; propulsion, control and guidance systems; and material properties combine to allow an aircraft to take flight and directly affect how the aircraft interacts with and moves through its atmospheric environment. As the aircraft moves through the atmosphere, the wings, fuselage, engines and engine nacelles, control surfaces, pylons, and antennae create and encounter a wide range of airflow patterns and pressures. Control of the airflow over, under, around and through the above aircraft structures has been the subject of constant study and refinement since the earliest days of flight. Often, even seemingly small changes in configuration have a dramatic effect on aircraft performance.

Various schemes for controlling airflow with respect to the wings have been developed in an attempt to enhance lift and reduce drag. Exemplary schemes include provision of a rotating cylinder at the leading and trailing edge of the wing, circulation control using tangential blowing at the leading and trailing edges, multi-element airfoils, pulsed jet separation control and the like. However, the penalty to the propulsion system (power loss) is often significant for some of the prior art flow control methods. For example, injecting or blowing air into the air flowing over a wing usually uses engine compressor bleed air. The mass flow rate of the engine bleed is directly proportional to the reduction of the thrust, i.e. the engine will suffer 1% thrust reduction for 1% blow rate used for wing flow control, and suffer 1-3% fuel consumption increase depending on whether the bleed is from the compressor front stage or back stage. To reduce the mass flow rate penalty due to blowing, pulsed jet or closed loop feed back control have been suggested. However, these methods require complicated actuation and sensor systems which may increase the degree of difficulty to implement the control system and increase the weight of the aircraft. Some flow control technologies also require moving parts, which may introduce complicated mechanical systems and increase weight.

It would be desirable to improve upon known structures, systems and techniques for flow control to enhance lift, reduce drag, and increase stall margin, among other flight characteristics, with minimal power loss or increased fuel consumption.

### SUMMARY OF THE INVENTION

The aerodynamic structure of the present invention improves upon known structures, systems and techniques for flow control with respect to an airfoil. In an exemplary embodiment, the aerodynamic structure includes an airfoil having an injection slot on the suction surface of the airfoil near the leading edge, as well as a recovery slot on the suction surface of the airfoil near the trailing edge. Employing a pressurized fluid source, which may include bleed air from an engine, a high-energy fluid jet is then injected near the leading edge tangentially along the suction surface of the airfoil, and substantially the same amount of mass flow is sucked in the recovery slot near the trailing edge, which can then be directed back into the circulation system of the engine.

### BRIEF DESCRIPTION OF THE DRAWINGS

A more complete understanding of the present invention, and the attendant advantages and features thereof, will be more readily understood by reference to the following detailed description when considered in conjunction with the accompanying drawings, wherein like designations refer to like elements, and wherein:

FIG. 1 illustrates a prior art, conventional airfoil and references thereto;

FIG. 2 shows a cross-section of an aerodynamic structure in accordance with the present invention;

FIG. 3 depicts a perspective view of the aerodynamic structure in accordance with the present invention;

FIG. 4 depicts an aerodynamic structure and flow system in accordance with the present invention;

FIG. 5 illustrates fluid streamline patterns of a prior art aerodynamic structure; and

FIG. 6 shows fluid streamline patterns of an aerodynamic structure in accordance with the present invention.

### DETAILED DESCRIPTION OF THE INVENTION

Prior to setting forth an exemplary embodiment of the present invention, the general characteristics and features of an airfoil will be identified and defined as referred to herein.

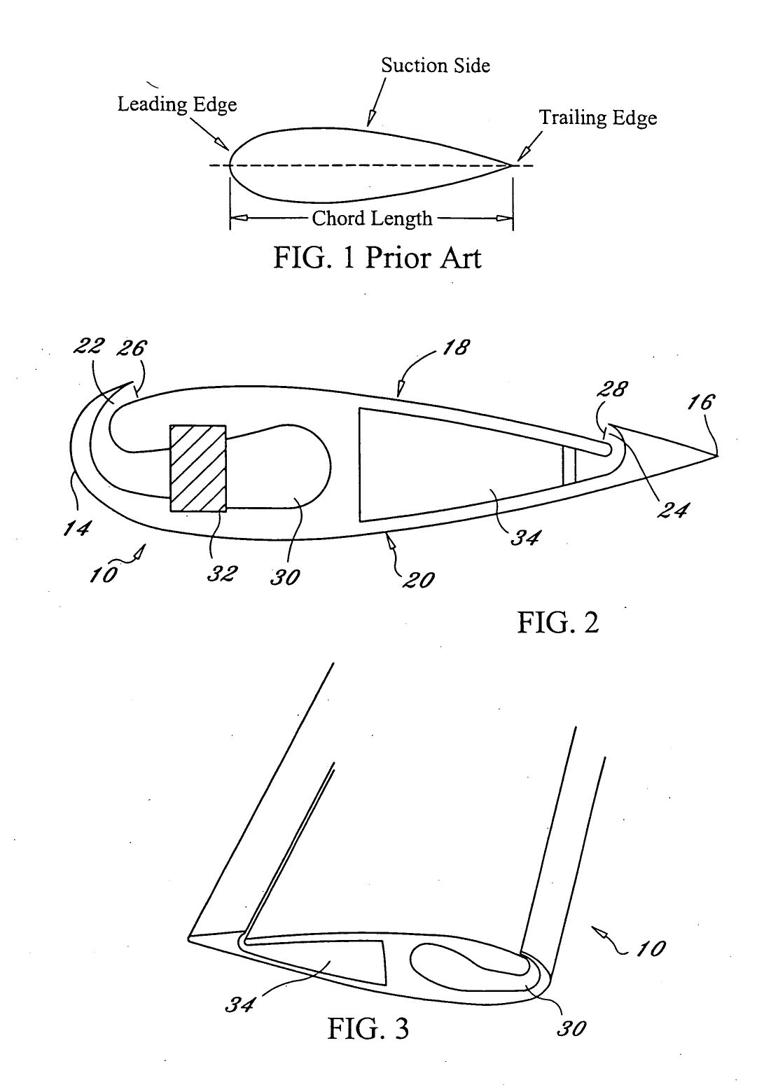

Now referring to FIG. 1, an airfoil generally includes a leading edge, a trailing edge, an “upper surface,” a “lower surface,” and a chord. The leading edge is that which encounters a fluid flow first, i.e., the “front” of the airfoil. The trailing edge is at the rear point of the airfoil, where the fluid flow over the upper surface meets the fluid flow across the lower surface of the airfoil.

Both the “upper” and “lower” surfaces are usually curved, with the “upper” surface having a larger curvature, and thus a larger surface length spanning from the leading edge to the trailing edge of the airfoil. Because the of the greater length across the “upper” surface, according to Bernoulli's theorem, the fluid flowing over the “upper” surface of the airfoil has a higher velocity than the fluid flowing across the “lower” surface of the airfoil. As a result of the increased velocity across the “upper” surface, a lower pressure is created than that experienced on the “lower” surface of the airfoil. This reduced pressure creates suction on the “upper” surface, which constitutes a portion of the lift created by the airfoil. As such, the “upper” surface is referred to herein as the suction surface of the airfoil. As an airfoil may be mounted in an inverted position, i.e., as a spoiler on a race car or the like, the suction side refers to the side experiencing a lower pressure when exposed to a fluid flow, and does not necessarily correlate to the “top” or “upper” surface of an airfoil or aerodynamic structure. Consequently, the “lower” surface as referred to herein will indicate the surface opposite the suction surface.

The chord of an airfoil is the straight line drawn through the airfoil from its leading edge to its trailing edge. Further, the chord length is the distance between the leading edge and trailing edge as traversed along the chord. Additionally, a fluid source or fluid flow as used herein can include both liquid as well as gaseous compositions of matter.

Now referring to FIGS. 2 and 3, the present invention provides an aerodynamic structure 10 having a chord length, a leading edge 14, and a trailing edge 16. As discussed previously, the leading edge 14 is the portion of the aerodynamic structure 10 which interacts with fluid first, i.e., the “front” of the structure 10, with the trailing edge 16 located at the rear point of the aerodynamic structure 10. The aerodynamic structure 10 further includes a first airfoil surface 18 that generally defines a surface extending from the leading edge 14 to the trailing edge 16. A second airfoil surface 20, which is opposite the first airfoil surface 18, also generally defines a surface extending from the leading edge 14 to the trailing edge 16. The first airfoil surface 18 corresponds to the suction side of the aerodynamic structure 10, i.e., the first airfoil surface 18 experiences a pressure lower than that experienced across the second airfoil surface 20 when the aerodynamic structure 10 is subjected to a fluid flow.

The first airfoil surface 18 also defines an injection opening 22 located between the leading edge 14 and the trailing edge 16, and further defines a recovery opening 24 located in between the injection opening 22 and the trailing edge 16. In an exemplary embodiment, the injection opening 22 is located less than 25% of the chord length form the leading edge 14 of the airfoil. However, the benefits of the present invention may be realized with the injection opening located within 80% of the chord length from the leading edge 14. Moreover, the recovery opening 24 is preferably located less than 25% of the chord length from the trailing edge 16 of the aerodynamic structure. Similarly to the injection opening placement, however, the benefits of the present invention may be realized with the recovery opening 24 located within 80% of the chord length from the trailing edge 16. The injection opening 22 defines an injection opening height 26, which has a value that is generally less than 5% of the chord length. The recovery opening 24 defines a similar recovery opening height 28, which has a value generally less than 5% of the chord length. While the injection and recovery openings illustrated have a fixed size, an alternative embodiment can include openings capable of having their height varied through the use of mechanical means in which at least a portion of the first airfoil surface 18 is moveable, thereby changing the height of either the injection opening 22 or the recovery opening 24.

Still referring to FIGS. 2 and 3, the aerodynamic structure 10 can further define a first cavity 30 that is in fluid communication with the injection opening 22. Optionally, the first cavity may further contain a baffle material 32. The baffle material 32 can include a foam-like substance that provides a uniform flow distribution of fluid flowing through it and further ensures a highly uniform fluid jet downstream of the baffle material 32. In addition to the first cavity 32, the aerodynamic structure 10 can also define a second cavity 34 coupled to the recovery opening 24.

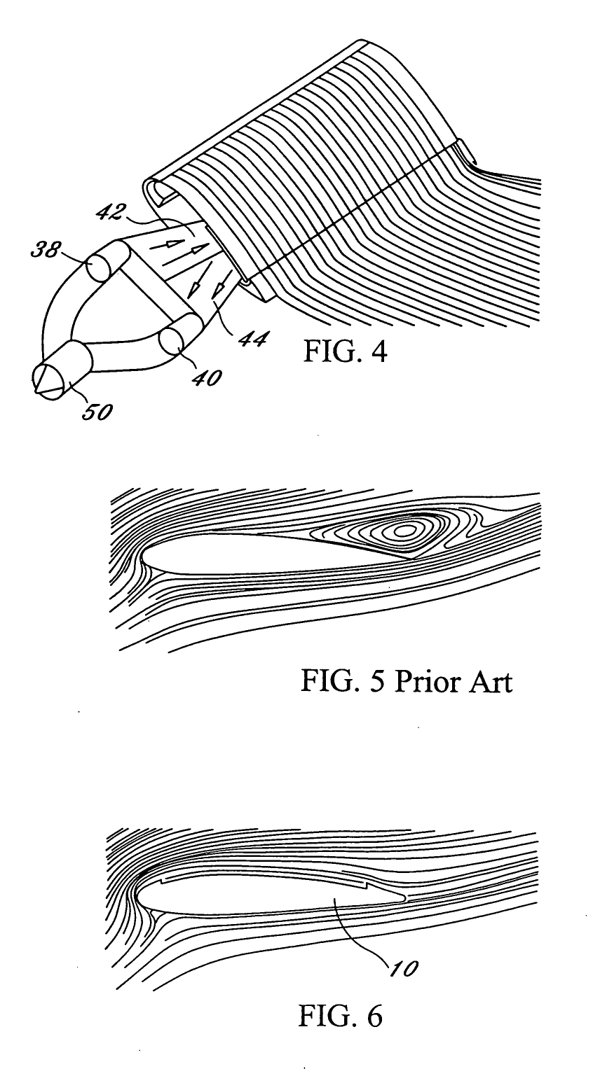

Now referring to FIG. 4, the present invention provides an aerodynamic system 36 that includes the aerodynamic structure 10 as previously described, as well as a pressurized fluid source 38 and a vacuum source 40. The vacuum source 40 provides a pressure lower than an ambient pressure. The pressurized fluid source 38 is in fluid communication with the injection opening 22 (see FIG. 2), and can include a pump or other means of pressurizing a fluid, and may further include bleed air from an engine 50. The vacuum source 40 is in fluid communication with the recovery opening 24 (see FIG. 2), and may also include a pumping apparatus or, alternatively, may be coupled to an engine.

Referring to FIGS. 2-4, An exemplary use of the aerodynamic system 36 provides a method for reducing the boundary layer separation of an aerodynamic structure. The aerodynamic system 36 is provided, which includes aerodynamic structure 10. A first mass 42 of fluid is routed from the pressurized fluid source 38 towards the injection opening 22. The first mass 42 may be routed by any means of conducting a fluid, i.e., a conduit, tubing, or the like. If the aerodynamic structure 10 includes the first cavity 30 coupled to the injection opening 22, then the fluid flow path will route the first mass 42 from the pressurized fluid source 38 and into the first cavity 30, where the first cavity acts as a plenum enclosing pressurized fluid at or near the injection opening 22. Additionally, the baffle material 32 provides a uniform flow distribution normal to the downstream surface of the baffle material 32 and insures a highly uniform jet of the first mass 42 of fluid as it heads towards the injection opening 22. The first mass 42 is then dispersed out of the injection opening 22 and directed substantially tangent to the exterior surface of the aerodynamic structure 10 and towards the recovery opening 24.

Concurrently, the vacuum source 40 creates a pressure at the recovery opening 24 lower than that of the environment external to the recovery opening 24, resulting in a second mass 44 of fluid being drawn into the recovery opening 24. The second mass can either be drawn into the recovery opening 24 and into the second cavity 34 coupled to the recovery opening, or, in the absence of the second cavity 34, the second mass of fluid can be drawn directly from the recovery opening towards the vacuum source. Further, while a single injection opening and recovery opening may extend along the span of the aerodynamic structure, alternatively, fluid may be dispensed from multiple injection openings along the span of the wing and recovered by numerous recovery openings also positioned along the span of the aerodynamic structure. Moreover, the injection and recovery openings may only span a portion of the aerodynamic structure, rather than the entire length.

Although the injection and recovery of fluid along the aerodynamic structure can be realized by separate and independent injection and recovery resources, the fluid flow can also be recirculated by a pump system or by an aircraft engine system. In jet aircraft, the high-pressure fluid in the rear stages of the engine compressor can be used for the fluid dispersion out of the injection opening 22. The second mass 44 can then be drawn into the recovery opening 24 and directed to the front stage of the compressor or the inlet where the pressure is low. The fluid-flow is hence recirculated to save energy expenditure. In non-jet or reciprocating engine powered craft, the fluid to the injection opening 22 can be provided by a pump or compressor driven by the engine. Further, the fluid can be provided by a compressed air supply, such as a pressurized tank.

FIG. 5 illustrates the fluid streamlines as they pass over a generic airfoil structure, with the separation of flow in the boundary layer towards the trailing edge clearly evident. FIG. 6 shows an aerodynamic structure in accordance with the invention. The first mass 42 forms a high-energy jet as it is injected tangentially along the structure and substantially the same amount of mass fluid flow is recovered near the trailing edge. The turbulent shear layer between the main flow and the high-energy jet formed by the dispersion of the first mass 42 of fluid causes strong turbulence diffusion and mixing; thereby enhancing the lateral transport of energy from the jet to the main flow, thereby allowing the main flow to overcome the severe adverse pressure gradient experienced towards the trailing edge of the aerodynamic structure. This diffusion allows the main flow to stay attached at high angle of attack (AOA), resulting in the removal of boundary layer separation. At a certain AOA, the aerodynamic structure of the present invention can achieve a significantly higher lift due to the augmented circulation. The operating range of AOA, and hence the stall margin, is significantly increased. Moreover, the energized main flow will fill the wake deficit and dramatically reduce the airfoil drag, or even generate thrust (negative drag). The filled wake will also reduce noise due to the weak wake mixing. In addition, the aerodynamic structure does not need a high lift flap system, further reducing noise. The method and systems described can be applied to any type of airfoil, including high-speed thin airfoils as well as low-speed, thicker airfoils.

In addition, since the aerodynamic system of the present invention disperses and recovers substantially the same amount of mass fluid flow, the high-energy fluid flow can be recirculated through the propulsion system and has a smaller energy expenditure to the overall airframe-propulsion system when compared to a method where only injection or dispersion of a mass of fluid is involved. Moreover, the lift can be controlled by adjusting the pressure at which the first mass 42 is injected along the surface of the aerodynamic structure 10, resulting in the absence of a need for moving parts.

In summary, the aerodynamic structure provides numerous advantages including both lift enhancement and separation suppression. The present invention tremendously reduces the drag, can achieve very high C_{L}/C_{D} (infinity when C_{D}=0) at low AOA (cruise), and high lift and drag at high AOA (take off and landing). Moreover, these advantages significantly increase the AOA operating range and stall margin, and further minimize the penalty to the propulsion system. The present invention can also be integrated into virtually any airfoil, whether thick or thin, in conventional, sweep wing configurations, and can be applied to helicopter rotor blades as well.

In addition, the above advantages of the aerodynamic structure of the present invention may derive superior aircraft performance for either a portion of or the entirety of a mission, which include increased fuel efficiency and shortened take-off and landing distances, and the integration of the systems of the present invention is simplified as moving parts are not necessary.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. An aerodynamic structure, comprising:
an airfoil comprised of a closed curve in cross section, said airfoil having a chord length, a leading edge, and a trailing edge, said airfoil comprising:
a first airfoil surface extending generally along said closed curve from the leading edge to the trailing edge with a portion of said first airfoil surface recessed below and locally substantially parallel to said closed curve, said portion having a leading edge portion closest to the leading edge and a trailing edge portion closest to the trailing edge; and
a second airfoil surface opposite the first airfoil surface, extending from the leading edge to the trailing edge;
an injection opening means, in the first airfoil surface located at said leading edge portion of said recessed surface, for providing blowing air therethrough in a direction substantially parallel to said leading edge portion of said recessed surface; and
a recovery opening means, in the first airfoil surface located at said trailing edge portion of said recessed surface, for recovering airflow into said recovery opening means.

2. (canceled)

3. The aerodynamic structure according to claim 1, wherein the injection opening means is located less than 25% of the chord length from the leading edge of the airfoil.

4. The aerodynamic structure according to claim 1, wherein the recovery opening means is located less than 25% of the chord length from the trailing edge of the airfoil.

5. The aerodynamic structure according to claim 1, wherein the injection opening means has a height that is less than 5% of the chord length.

6. The aerodynamic structure according to claim 1, wherein the recovery opening means has a height that is less than 5% of the chord length.

7. The aerodynamic structure according to claim 1, wherein the airfoil further defines a first cavity coupled to the injection opening means.

8. The aerodynamic structure according to claim 7, further comprising a baffle material within the first cavity providing uniform fluid flow distribution.

9. The aerodynamic structure according to claim 7, wherein the airfoil further defines a second cavity coupled to the recovery opening means.

10. An aerodynamic system, comprising:
an airfoil comprised of a closed curve in cross section, said airfoil having a chord length, a leading edge, and a trailing edge, said airfoil comprising:
a first airfoil surface extending generally along said closed curve from the leading edge to the trailing edge with a portion of said first airfoil surface recessed below and locally substantially parallel to said closed curve, said portion having a leading edge portion closest to the leading edge and a trailing edge portion closest to the trailing edge;
a second airfoil surface opposite the first airfoil surface, extending from the leading edge to the trailing edge;
an injection opening means, in the first airfoil surface located at said leading edge portion of said recessed surface, for providing blowing air therethrough in a direction substantially parallel to said leading edge portion of said recessed surface;
a recovery opening means in the first airfoil surface located at said trailing edge portion of said recessed surface, for recovering airflow into said recovery opening means;
a pressurized fluid source in fluid communication with the injection opening means; and
a vacuum source in fluid communication with the recovery opening means.

11. The aerodynamic system according to claim 10, wherein the pressurized fluid source is bleed air from an engine.

12. The aerodynamic system according to claim 10, wherein the vacuum source is coupled to an engine fluid path.

13. (canceled)

14. The aerodynamic system according to claim 10, wherein the airfoil further defines a first cavity coupled to the injection opening means.

15. The aerodynamic system according to claim 14, further comprising a baffle material located within the first cavity.

16. The aerodynamic system according to claim 14, wherein the airfoil further defines a second cavity coupled to the recovery opening means.

17. The aerodynamic system according to claim 10, wherein the injection opening means is located less than 25% of the chord length from the leading edge of the airfoil.

18. The aerodynamic system according to claim 10, wherein the recovery opening means is located less than 25% of the chord length from the trailing edge of the airfoil.

19. The aerodynamic system according to claim 10, wherein the injection opening means has a height that is less than 5% of the chord length.

20. The aerodynamic system according to claim 10, wherein the recovery opening means has a height that is less than 5% of the chord length.

21. An aerodynamic system, comprising:
an airfoil comprised of a closed curve in cross section, said airfoil having a chord length, a leading edge, and a trailing edge, said airfoil comprising:
a first airfoil surface extending generally along said closed curve from the leading edge to the trailing edge with a portion of said first airfoil surface recessed below and locally substantially parallel to said closed curve, said portion having a leading edge portion closest to the leading edge and a trailing edge portion closest to the trailing edge; and
a second airfoil surface opposite the first airfoil surface, extending from the leading edge to the trailing edge;
an injection opening in the first airfoil surface located at said leading edge portion of said recessed surface, for providing blowing air therethrough in a direction substantially parallel to said leading edge portion of said recessed surface;
a recovery opening in the first airfoil surface located between the injection opening and the trailing edge;
a first cavity in fluid communication with the injection opening;
a second cavity in fluid communication with the recovery opening;
a pressurized fluid source coupled to the first cavity; and
a vacuum source coupled to the second cavity.

22. The aerodynamic system according to claim 21, wherein the pressurized fluid source is bleed air from an engine.

23. The aerodynamic system according to claim 21, wherein the injection opening is located less than 25% of the chord length from the leading edge of the airfoil.

24. The aerodynamic system according to claim 21, wherein the recovery opening is located less than 25% of the chord length from the trailing edge of the airfoil.

25. The aerodynamic system according to claim 21, wherein the injection opening has a height that is less than 5% of the chord length.

26. The aerodynamic system according to claim 21, wherein the recovery opening has a height that is less than 5% of the chord length.

27. A method for reducing boundary layer separation of an aerodynamic structure, said method comprising the steps of:
providing an airfoil comprised of a closed curve in cross section, said airfoil defining an injection opening and a recovery opening with a portion of said airfoil between said injection opening and said recovery opening recessed below and locally substantially parallel to said closed curve;
discharging a first mass of fluid from the injection opening tangentially along said recessed portion of said airfoil; and
receiving a second mass of fluid into the recovery opening.

28. The method of claim 27, wherein the first mass of fluid is substantially equal in amount to the second mass of fluid.

29. The method of claim 27, wherein the second mass of fluid is less in amount than the first mass of fluid.

30. A method for enhancing aircraft performance, comprising the steps of:
providing an airfoil comprised of a closed curve in cross section, said airfoil having a chord length, a leading edge, and a trailing edge, said airfoil comprising:
an airfoil surface extending generally along said closed curve from the leading edge to the trailing edge with a portion of said airfoil surface recessed below and locally substantially parallel to said closed curve, said portion having a leading edge portion closest to the leading edge and a trailing edge portion closest to the trailing edge;
an injection opening in the airfoil surface;
a recovery opening in the airfoil surface located between the injection opening and the trailing edge;
a pressurized fluid source in fluid communication with the injection opening; and
a vacuum source in fluid communication with the recovery opening;
routing a first mass of fluid from the pressurized fluid source to the injection opening, where the first mass of fluid is dispersed out of the injection opening in a direction substantially parallel to said leading edge portion of said recessed surface and into the atmosphere external to the airfoil; and
using the vacuum source to draw a second mass of fluid into the recovery opening.

31. The method according to claim 30, wherein the pressurized fluid source is bleed air from an engine.

32. The method according to claim 30, wherein the vacuum source is coupled to an engine fluid path.

33. The method according to claim 30, wherein the second mass of fluid is routed from the recovery opening to an engine.

34. The method according to claim 30, wherein the first mass of fluid is substantially equal in amount to the second mass of fluid.

35. The method according to claim 30, wherein the enhanced aircraft performance is reduced boundary layer separation.

36. The method according to claim 30, wherein the enhanced aircraft performance is reduced drag.

37. The method according to claim 30, wherein the enhanced aircraft performance is increased stall margin.

38. The method according to claim 30, wherein the enhanced aircraft performance is enhanced lift.

39. An aerodynamic structure, comprising:
an airfoil comprised of a closed curve in cross section, said airfoil having a chord length, a leading edge, and a trailing edge, said airfoil comprising:
a first airfoil surface extending generally along said closed curve from the leading edge to the trailing edge with a portion of said first airfoil surface recessed below said closed curve, said portion having a leading edge portion closest to the leading edge and a trailing edge portion closest to the trailing edge; and
a second airfoil surface opposite the first airfoil surface, extending from the leading edge to the trailing edge;
an injection opening in the first airfoil surface located at said leading edge portion of said recessed surface, for providing blowing air over said recessed surface; and
a recovery opening in the first airfoil surface located at said trailing edge portion of said recessed surface, for recovering airflow into said recovery opening.
